(19) United States
(12) Patent Application Publication
(10) Pub. No.: US 2016/0011863 A1
(43) Pub. Date: Jan. 14, 2016

(54) Updating Software on Marine Electronics Device

(71) Applicant: Navico Holding AS, Egersund (NO)

(72) Inventors: Tom Isaacson, Auckland (NZ); Shane Coloney, Jenks, OK (US)

(21) Appl. No.: 14/622,483

(22) Filed: Feb. 13, 2015

Related U.S. Application Data
(60) Provisional application No. 62/040,767, filed on Aug. 22, 2014.
(60) Provisional application No. 62/022,064, filed on Jul. 8, 2014.

(51) Int. Cl. G06F 9/445; H04L 29/08

(52) U.S. Cl. CPC G06F 8/65; H04L 67/10

(57) ABSTRACT

Various implementations described herein are directed to a non-transitory computer readable medium having stored thereon computer-executable instructions which, when executed by a computer, may cause the computer to receive information from a marine electronics device. The received information describes the current software version of a software application configured to run on the marine electronics device or a peripheral device in communication with the marine electronics device. The computer may determine whether an update exists for the software application based on the received information. The computer may also provide a download for the update to the marine electronics device in response to a determination that the update exists.

### CROSS-REFERENCE TO RELATED APPLICATIONS

This application claims the benefit of U.S. Provisional Patent Application Ser. No. 62/022,064, filed Jul. 8, 2014, titled VARIOUS SOFTWARE FEATURES FOR MARINE ELECTRONICS DEVICE, and the disclosure of which is incorporated herein by reference.

This application claims the benefit of U.S. Provisional Patent Application Ser. No. 62/040,767, filed Aug. 22, 2014, titled VARIOUS SOFTWARE FEATURES FOR MARINE ELECTRONICS DEVICE, and the disclosure of which is also incorporated herein by reference

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Various forms of marine electronics data may be processed and/or displayed using a computing device disposed aboard a vessel. In one scenario, the computing device may include a multi-function display (MFD). Marine electronics data displayed using the computing device may be used to help navigate the vessel, and the data may include, for example, sonar data, chart data, radar data, or navigation data such as laylines.

### SUMMARY

Described herein are implementations of various technologies for a marine electronics device. The device includes one or more processors and a memory. The memory has a plurality of executable instructions. When the executable instructions are executed by the one or more processors, the processors may determine the current software version of a software application that is configured to run on the marine electronics device or a peripheral device in communication with the marine electronics device. The processors may receive information from a cloud server. The received information describes one or more software versions released for the software application. The processors may determine whether an update exists for the software application based on the received information and the current software version. The processors may also download the update in response to a determination that the update exists.

Described herein are also implementations of various technologies for providing a download for an update to a marine electronics device. In one implementation, a non-transitory computer-readable medium having stored thereon computer-executable instructions which, when executed by a computer, cause the computer to perform various actions. The actions may include receiving information from a marine electronics device. The received information describes the current software version of a software application configured to run on the marine electronics device or a peripheral device in communication with the marine electronics device. The actions may include determining whether an update exists for the software application based on the received information. The actions may also include providing a download for the update to the marine electronics device in response to a determination that the update exists.

Described herein are also implementations of various technologies for a handheld computer device. The device includes one or more processors and a memory. The memory has a plurality of executable instructions. When the executable instructions are executed by the one or more processors, the processors may receive information from a marine network. The received information from the marine network describes the current software version of a software application that is configured to run on a marine electronics device or a peripheral device in communication with the marine electronics device. The processors may receive information from a cloud server. The received information describes one or more software versions released for the software application. The processors may determine whether an update exists for the software application based on the received information from the marine network and the received information from the cloud server. The processors may also download the update in response to a determination that the update exists.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a marine networking system in accordance with implementations of various techniques described herein.

FIG. 2 is a flow diagram of a method for updating software in accordance with implementations of various techniques described herein.

FIG. 3 is a flow diagram of a method for updating software in accordance with implementations of various techniques described herein.

FIG. 4 is a flow diagram of a method for updating software in accordance with implementations of various techniques described herein.

FIG. 5 illustrates a schematic of a marine electronics device in accordance with implementations of various techniques described herein.

FIG. 6 illustrates a schematic diagram of a computing system in which the various technologies described herein may be incorporated and practiced.

### DETAILED DESCRIPTION

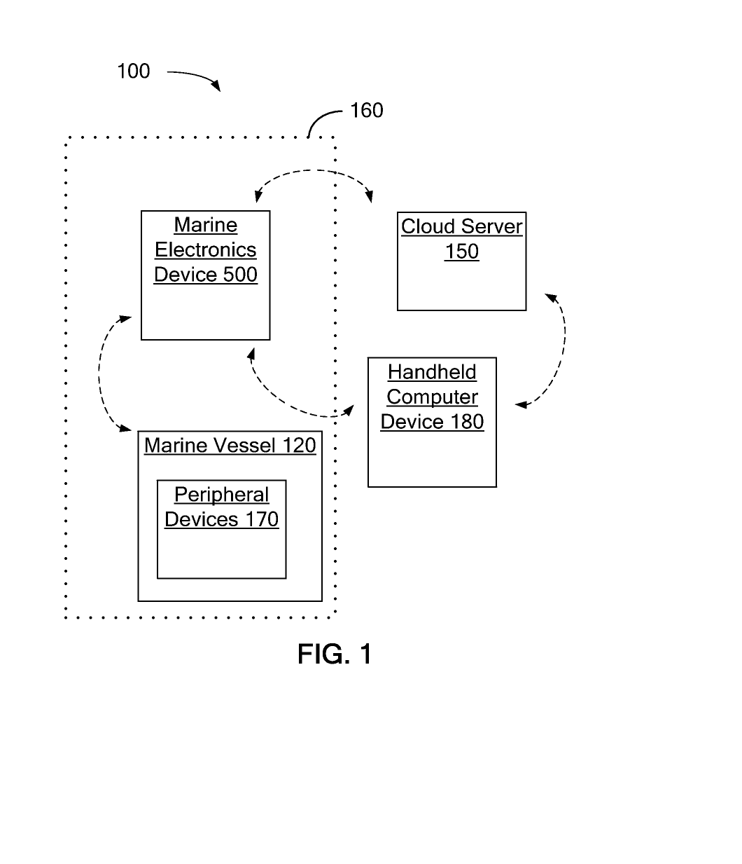

FIG. 1 illustrates a block diagram of a marine networking system 100 in accordance with implementations of various techniques described herein. The marine networking system 100 may include several components, such as a marine electronics device 500 (which may be a multi-function display or a chartplotter), a cloud server 150, a handheld computer device 180 (e.g., a tablet, a smartphone, etc.), a marine vessel 120, and peripheral devices 170 disposed on a marine vessel 120 that may be in communication with the marine electronics device 500. The cloud server 150 may be a server located on the Internet, which may be operated by a vendor. A web browser may be included in the user interface of the marine electronics device 500. As such, a user may use the web browser to connect to the cloud server 150 over the Internet. The marine electronics device 500 may collect data from the marine networking system 100, as well as manage and control various navigation related systems and the peripheral devices 170. For more information regarding the marine electronics device 500, see the section titled MARINE ELECTRONICS DEVICE below.

The peripheral devices 170 may include a sonar system, a Global Positioning System (GPS) device, such as a GPS receiver or a similar device such as GLONASS or global navigation satellite system (GNSS) receiver, a radar system, a propulsion system, various navigation systems, and any other systems, such as lighting systems, wireless data communication devices, wireless audio communications devices, audio and video entertainment devices, weather and environmental sensor systems, etc., disposed onboard the marine vessel 120.

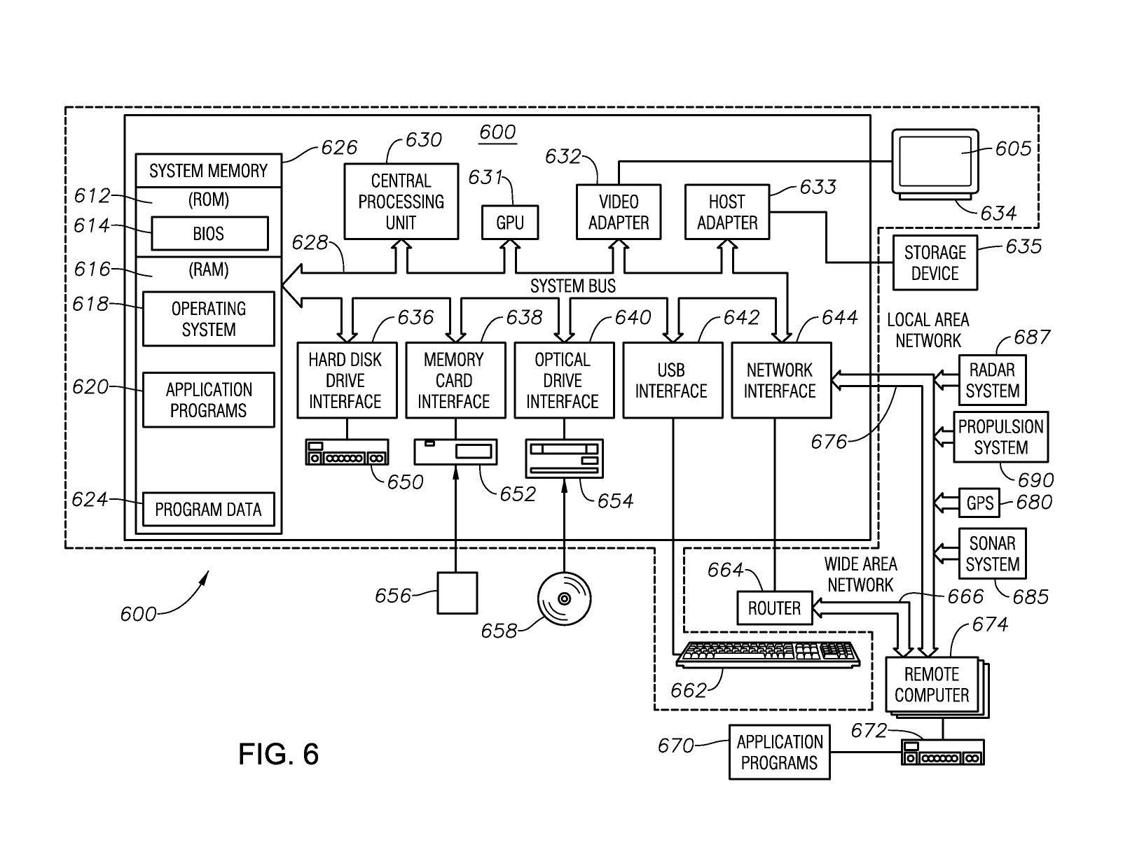

Furthermore, the marine electronics device 500 may be connected to the peripheral devices 170 over a marine network 160 operated onboard the marine vessel 120. Components on the marine network 160 may communicate using a National Marine Electronics Association (NMEA) communication protocol or other mutually compatible protocol. For instance, the router 664 described in FIG. 6 below may provide one or more network connections between components on the marine network 160. As such, the marine network 160 may be a local area network that includes the handheld computer device 180, the marine electronics device 500 and the peripheral devices 170.

The marine electronics device 500 or the peripheral devices 170 may be associated with a user or user account. As such, a respective user may set up a user account with the cloud server 150. The respective user may register the marine electronics device 500, the marine vessel 120, the handheld computer device 180, or the peripheral devices 170 to the user account. The user account may be associated with security information (e.g., an account identification, an account password, etc.), a personal profile (e.g., customer identification, such as name, address, phone number, etc.), product information (e.g., product serial numbers, the type of marine electronics device 500, the type of the marine vessel 120, and other component information such as for a radar system or sonar system, etc.), and financial information (e.g., customer billing information, credit card information, purchase history, etc.). Account information may be stored on the cloud server 150. The respective user may access and modify information stored in the user account to verify accuracy. Security measures may be put in place to maintain the respective user's privacy and protect sensitive personally identifiable information.

In some implementations, the user account may be associated with an online profile, such as a profile that is visible to other users on a social networking site. The online profile may also be used to display information collected by the marine electronics device 500, the handheld computer device 180, or from the peripheral devices 170. As such, the handheld computer device 180 or the marine electronics device 500 may manage information in the online profile by changing various settings (e.g., privacy settings regarding which users, such as social media friends, are able to access the online profile, or information settings regarding what information is collected or displayed with respect to the user, etc.) or information stored in the user account. The online profile may also be synchronized with one or more respective social networking sites, where a change to information in the online profile may change the information displayed in the respective social networking sites.

### Updating Software

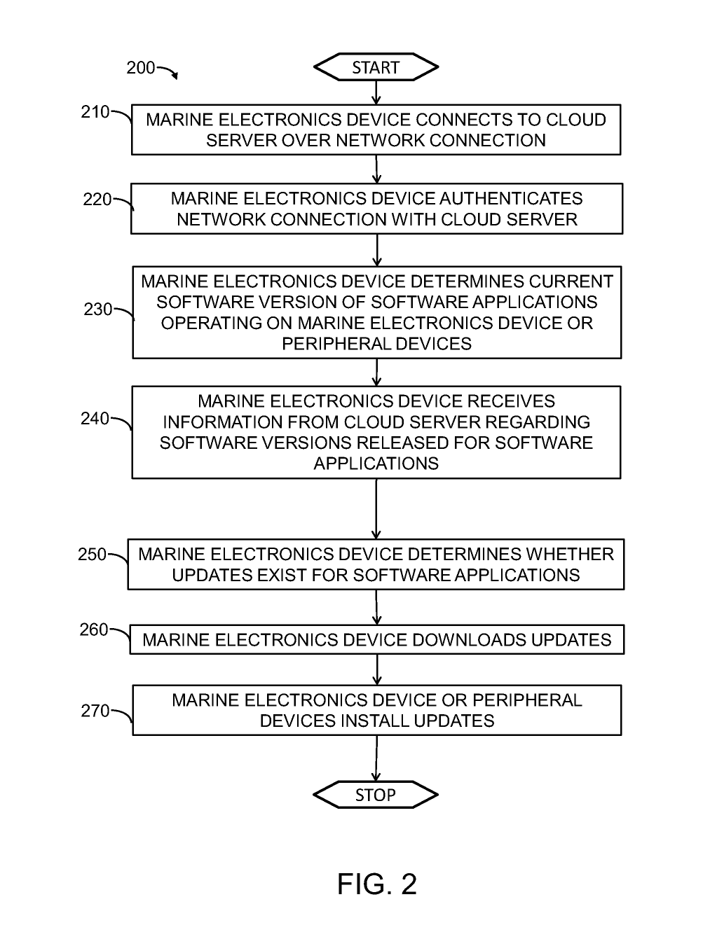

FIG. 2 illustrates a flow diagram for a method 200 for updating software in accordance with implementations of various techniques described herein. In one implementation, method 200 may be performed by the marine electronics device 500. It should be understood that while method 200 indicates a particular order of execution of operations, in some implementations, certain portions of the operations might be executed in a different order. Further, in some implementations, additional operations or blocks may be added to the method 200. Likewise, some operations or blocks may be omitted.

At block 210, the marine electronics device 500 may connect to the cloud server 150 over a network connection. The network connection may be a wireless connection or a wired connection, e.g., an Ethernet connection. The marine electronics device 500 may search for Internet access, for instance, and determine whether a network connection to the cloud server 150 exists over the Internet. For a wireless connection, the marine electronics device 500 may search for a wireless access point, such as a nearby router, WiFi hotspot or cellular tower, which may be broadcasting proximate the marine electronics device 500. If no network connection is found to the cloud server 150, the marine electronics device 500 may perform another check for a network connection after a predetermined amount of time until a network connection is established.

At block 220, the marine electronics device 500 may authenticate the network connection from block 210 with the cloud server 150 (also referred to as a “handshake”). To authenticate the network connection, the marine electronics device 500 may send security information (e.g., password information) to the cloud server 150 to verify that the marine electronics device 500 is associated with a particular user or user account. As such, the security information may correspond to information stored in a designated user account on the cloud server 150.

If the cloud server 150 verifies that the security information matches a designated user account, the cloud server 150 may create a secure connection with the marine electronics device 500. The secure connection may encrypt information that is sent between the cloud server 150 and the marine electronics device 500. Once a secure connection has been established, the cloud server 150 may provide the marine electronics device 500 with access to one or more features, e.g., receiving information regarding released software versions of software applications below at block 240.

At block 230, the marine electronics device 500 may determine the current software version of one or more software applications (i.e., “the software applications”) operating/running on (or configured to run on) the marine electronics device 500 or the peripheral devices 170. For instance, the current software version may be identified by a software application's installation date, or one or more identifiers associated with the software application, such as a version number, a date regarding the version's release, etc. The software applications may include system software, firmware, drivers, third-party programs, or programs designed to carry out operations for one or more specific applications, such as a web browser, a user interface, navigation software, etc.

For a software application operating on the marine electronics device 500, the marine electronics device 500 may verify the current software version from the local files stored in memory or on the hard disk of the marine electronics device 500. For a software application on the peripheral devices 170, the marine electronics device 500 may send a command to a corresponding peripheral device. The command may request a notification from the corresponding peripheral device regarding the current software version of a particular software application. As such, the corresponding peripheral device may send a response that identifies the current software version, e.g., the response may include the version number of the particular software application.

At block 240, the marine electronics device 500 may receive information from the cloud server 150 regarding one or more software versions (i.e., “the released software versions”) that are released for the software applications. For instance, the received information at block 240 may be a message that identifies the most recent version of a particular software application. The released software versions may be identified in a manner similar to how a current software version was identified at block 230. In one implementation, the received information may be a message notifying the marine electronics device 500 of a new update available for a particular software application.

In another implementation, the received information at block 240 may include a list describing the software versions for a plurality of software applications. In another implementation, the marine electronics device 500 may send a list to the cloud server 150 that describes various software applications that are installed on the marine electronics device 500 or the peripheral devices 170. In response, the cloud server 150 may send a list that describing the software versions for the various software applications.

At block 250, the marine electronics device 500 may determine whether one or more updates (i.e., “the updates”) exist for the software applications based on the received information at block 240. As such, an update at block 250 may include a patch or a programming fix for a particular software application. In one implementation, an update may include new data for a software library or database (e.g., additional virus definitions for antivirus software), software add-ons, replacement software (i.e., one software application may replace another software application, such as a new antivirus program may be used in place of the previous antivirus program), updates to firmware, etc.

In another implementation, the updates may be for navigational data or other marine data types (e.g., the marine electronic data types 615 described in the section titled MARINE ELECTRONICS DEVICE below) stored on the marine electronics device 500 or the peripheral devices 170. For instance, an update at block 250 may include sonar data for use by the marine electronics device 500. As such, the sonar data may be for underwater regions mapped by other marine vessels and not previously stored on the marine electronics device 500.

In another implementation, where the received information at block 240 identifies the most recent software version of a particular software application, the marine electronics device may compare the most recent software version with current software version determined at block 230 of a particular software application operating on a device. For instance, if the date or version number of the most recent software version is the same as the current software version, the marine electronics device 500 may determine that no update is present for the particular software application.

In another implementation, if the received information includes a message that a new update exists for a particular software application, the marine electronics device 500 may verify at block 250 that the particular software application is operating on the marine electronics device 500 or one of the peripheral devices 170.

At block 260, the marine electronics device 500 may download the updates determined at block 250. For instance, the marine electronics device 500 may download the updates directly from the cloud server 150 or a location designated by the cloud server 150. In one implementation, the marine electronics device 500 may request an update for a specific software application from the cloud server 150. In response to the request, the cloud server 150 may send a URL or website address to the marine electronics device 500 for a location of an update. As such, the marine electronics device 500 may download the update from that location.

At block 270, the marine electronics device 500 or the peripheral devices 170 may install the updates downloaded at block 260. For software installations on the peripheral devices 170, the marine electronics device 500 may move the files regarding an update to the corresponding peripheral device 170. With the files, the corresponding peripheral device 170 may automatically install the update. In other implementations, the marine electronics device 500 may manually configure an update on the corresponding peripheral device 170.

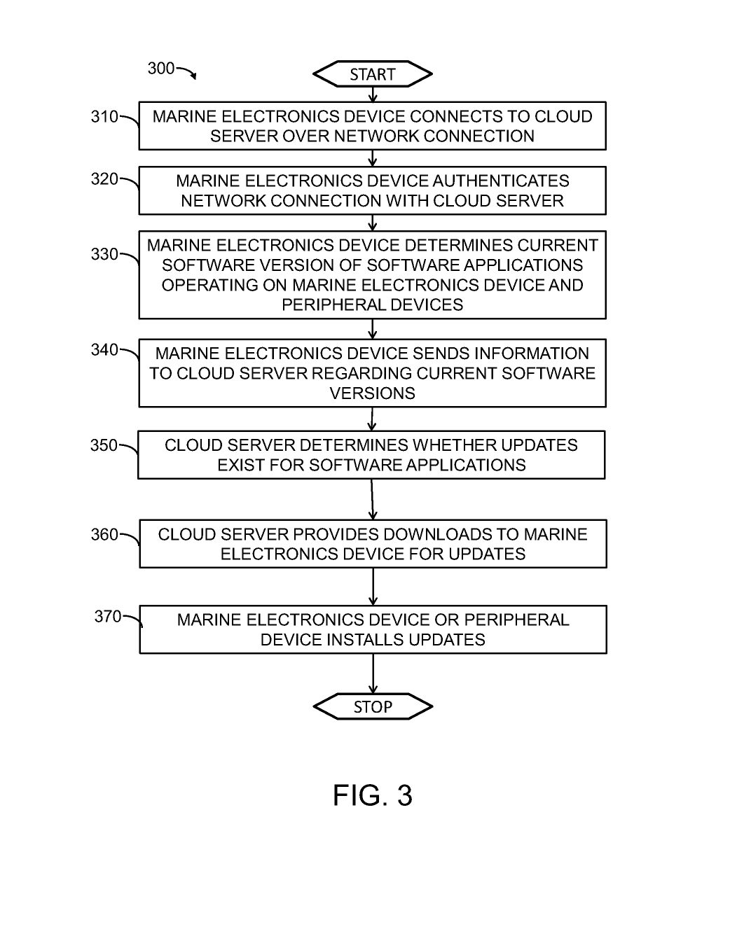

FIG. 3 illustrates a flow diagram for a method 300 for updating software in accordance with implementations of various techniques described herein. In one implementation, method 300 may be performed by the marine electronics device 500 and/or the cloud server 150. It should be understood that while method 300 indicates a particular order of execution of operations, in some implementations, certain portions of the operations might be executed in a different order. Further, in some implementations, additional operations or blocks may be added to the method 300. Likewise, some operations or blocks may be omitted.

At block 310, the marine electronics device 500 may connect to the cloud server 150 over a network connection. The network connection at block 310 may be similar to the network connection described at block 210 above.

At block 320, the marine electronics device 500 may authenticate the network connection from block 310 with the cloud server 150. The authentication at block 320 may be similar to the authentication described at block 220 above.

At block 330, the marine electronics device 500 may determine the current software version of one or more software applications operating/running (or configured to run) on the marine electronics device 500 or the peripheral devices 170. The determination at block 330 may be similar to the determination described at block 230 above.

At block 340, the marine electronics device 500 may send information (i.e., “the sent information”) to the cloud server 150 regarding one or more current software versions determined at block 330. As such, the sent information may identify the current software version of a respective software application in a similar manner described at block 230 above. For instance, the sent information may include a list that describes the current software versions for a plurality of respective software applications operating on the marine electronics device 500 or the peripheral devices 170.

At block 350, the cloud server 150 may determine whether one or more updates exist for the software applications based on the sent information from block 340. The updates at block 350 may be similar to the updates described at block 250 above. In determining whether an update exists, the cloud server 150 may compare the sent information with one or more released software versions known by the cloud server 150.

In one implementation, the cloud server 150 may have a database that includes a history of software versions for various software applications. The cloud server 150 may compare the sent information with corresponding information in the database. In another implementation, a particular software application may correspond to a remote server. For example, the remote server may be run by a third party or a vendor. The cloud server 150 may communicate with the remote server associated with a particular software application to determine the most recent software version of the particular software application.

At block 360, the cloud server 150 may provide one or more downloads to the marine electronics device 500 for the updates determined at block 350. For instance, if a particular software application is associated with a remote server, the cloud server 150 may send a link to the marine electronics device 500 for the remote server. Using the link, the marine electronics device 500 may download the update from the remote server.

At block 370, the marine electronics device 500 or the peripheral devices 170 may install the updates downloaded at block 360. The updates may be installed at block 370 in a similar manner as described at block 270 above.

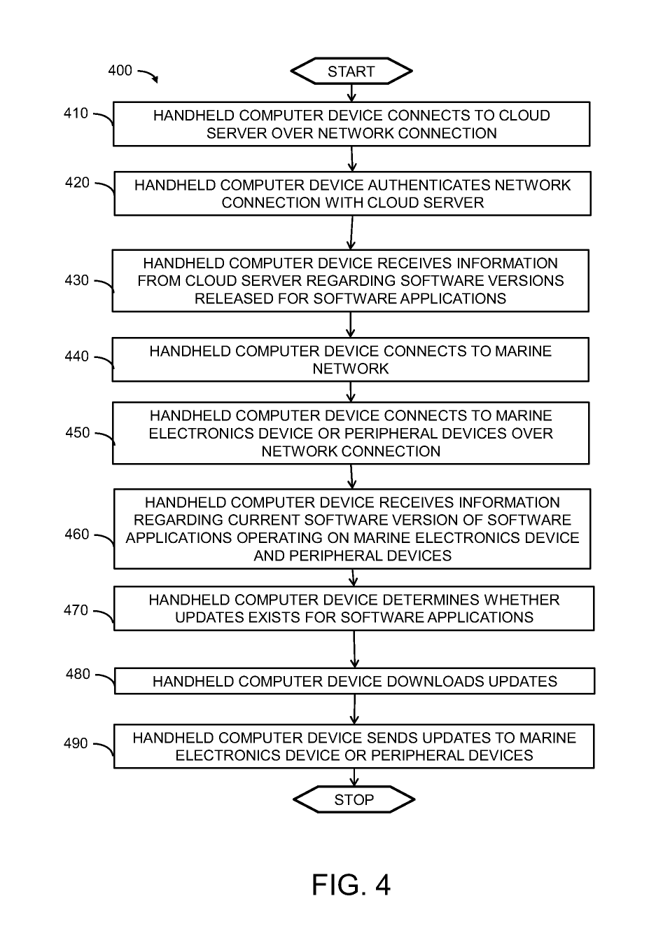

FIG. 4 illustrates a flow diagram for a method 400 for updating software in accordance with implementations of various techniques described herein. In one implementation, method 400 may be performed by the handheld computer device 180. It should be understood that while method 400 indicates a particular order of execution of operations, in some implementations, certain portions of the operations might be executed in a different order. Further, in some implementations, additional operations or blocks may be added to the method 400. Likewise, some operations or steps may be omitted.

At block 410, the handheld computer device 180 may connect to the cloud server 150 over a network connection. The network connection at block 410 may be similar to the network connection described at block 210 above.

At block 420, the handheld computer device 180 may authenticate the network connection from block 410 with cloud server 150. The authentication at block 420 may be similar to the authentication described at block 220 above.

At block 430, the handheld computer device 180 may receive information from the cloud server 150 regarding one or more software versions (i.e., “the released software versions”) of various software applications released for the marine electronics device 500 or the peripheral devices 170. The received information at block 430 may be similar to the received information from the cloud server 150 described at block 240 above.

At block 440, the handheld computer device 180 may connect to the marine network 160. For instance, the handheld computer device 180 may connect to router 664 for accessing the marine network 160. Once connected to the router 664, the handheld computer device 180 may scan the marine network 160 for other network devices, which may include the marine electronics device 500 or the peripheral devices 170.

At block 450, the handheld computer device 180 may connect to the marine electronics device 500 or the peripheral devices 170 over a network connection. As such, the handheld computer device 180 may communicate individually with the marine electronics device 500 or the peripheral devices 170 over a network connection provided by the marine network 160 at block 440.

At block 460, the handheld computer device 180 may receive information regarding the current software version of one or more software applications that are operated/running on (or configured to run on) the marine electronics device 500 or the peripheral devices 170. The received information at block 460 may be similar to the sent information described at block 340 above. The received information at block 460 may be sent over the network connection described at block 450. As such, the marine electronics device 500 may collect the current software versions of software applications operating on various network devices on the marine network 160, and send information describing the current software versions to the handheld computer device 180. For instance, the received information may be a list similar to the lists described at block 240 or block 340 above.

At block 470, the handheld computer device 180 may determine whether one or more updates (i.e., “the updates”) exist for the software applications based on the received information from block 430 or block 460. For instance, the handheld computer device 180 may determine whether an update exists in a manner similar to that described at block 250 above.

In one implementation, the handheld computer device 180 may forward the received information from block 460 to the cloud server 150 in a similar manner as described at block 340. As such, the cloud server 150 may determine whether one or more updates exist for the software applications in a similar manner as described at block 350. The cloud server 150 may communicate with the handheld computer device 180 regarding which updates exist for which software applications.

At block 480, the handheld computer device 180 may download the one or more updates determined at block 470 for the software applications. The handheld computer device 180 may download the updates in a similar manner as described at block 260 or block 360 above.

At block 490, the handheld computer device 180 may send the updates downloaded at block 480 to the marine electronics device 500 or the peripheral devices 170. The marine electronics device 500 or the peripheral devices may install the updates in a similar manner as described at block 270 or block 370 above.

While updates are described above for the most recent version of software applications, the above methods 200, 300 and 400 may be used for updating various software versions for a variety of different reasons. For instance, an update may be tailored to address a specific problem on a particular software application and may not simply be the most recent update available for that particular software application. As such, updates for various software applications may be selected for a variety of different reasons.

### Marine Electronics Device

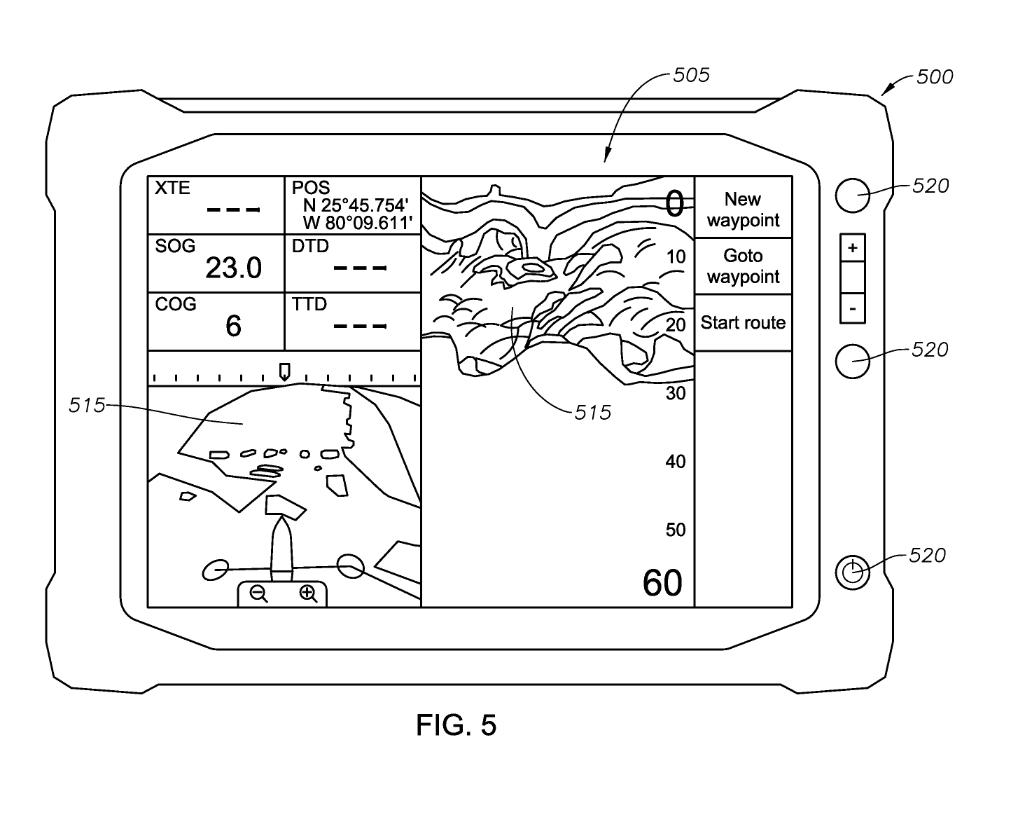

FIG. 5 illustrates a schematic diagram of a marine electronics device 500 in accordance with various implementations described herein. The components of the marine display device 500 are described in more detail with reference to the computing system 600 in FIG. 5. The marine electronics device 500 includes a screen 505. In certain implementations, the screen 505 may be sensitive to touching by a finger. In other implementations, the screen 505 may be sensitive to the body heat from the finger, a stylus, or responsive to a mouse. The display device 500 may display marine electronic data 515. The marine electronic data types 515 may include chart data, radar data, sonar data, steering data, dashboard data, navigation data, fishing statistics, vessel systems data, and the like. The marine electronics device 500 may also include a plurality of buttons 520, which may be either physical buttons or virtual buttons, or a combination thereof.

### Computing System

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computer, and the like.

Various technologies described herein may be implemented in the context of marine electronics, such as devices found in marine vessels and/or navigation systems. Ship instruments and equipment may be connected to the computing systems described herein for executing one or more navigation technologies. As such, the computing systems may be configured to operate using sonar, radar, the global positioning system (GPS), propulsion systems, and like technologies.

Various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

Various technologies described herein may be implemented in computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

FIG. 6 illustrates a schematic diagram of the waypoint generation system 100 having a computing system 600 in accordance with implementations of various techniques described herein. The computing system 600 may be the marine electronics device 500, conventional desktop, a handheld device, a controller, a personal digital assistant, a server computer, an electronics device/instrument, a laptop, a tablet, or part of a navigation system, or sonar system. It should be noted, however, that other computer system configurations may be used.

The computing system 600 may include a central processing unit (CPU) 630, a system memory 626, a graphics processing unit (GPU) 631 and a system bus 628 that couples various system components including the system memory 626 to the CPU 630. Although only one CPU 630 is illustrated in FIG. 6, it should be understood that in some implementations the computing system 600 may include more than one CPU 630.

The CPU 630 can include a microprocessor, a microcontroller, a processor, a programmable integrated circuit, or a combination thereof. The CPU 630 can comprise an off-the-shelf processor such as a Reduced Instruction Set Computer (RISC), including an Advanced RISC Machine (ARM) processor, or a Microprocessor without Interlocked Pipeline Stages (MIPS) processor, or a combination thereof. The CPU 630 may also include a proprietary processor. The CPU 630 may include a multi-core processor.

The GPU 631 may be a microprocessor specifically designed to manipulate and implement computer graphics. The CPU 630 may offload work to the GPU 631. The GPU 631 may have its own graphics memory, and/or may have access to a portion of the system memory 626. As with the CPU 630, the GPU 631 may include one or more processing units, and each processing unit may include one or more cores.

The CPU 630 may provide output data to a GPU 631. The GPU 631 may generate graphical user interfaces that present the output data. The GPU 631 may also provide objects, such as menus, in the graphical user interface. A user may provide inputs by interacting with the objects. The GPU 631 may receive the inputs from interaction with the objects and provide the inputs to the CPU 630. A video adapter 632 may be provided to convert graphical data into signals for a monitor 634. The monitor 634 includes a screen 605. The screen 605 can be sensitive to heat or touching (now collectively referred to as a “touch screen”). In one implementation, the host computer 699 may not include a monitor 634. In one implementation, the CPU 630 may perform the tasks of the GPU.

The system bus 628 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral device Interconnect (PCI) bus also known as Mezzanine bus. The system memory 626 may include a read only memory (ROM) 612 and a random access memory (RAM) 616. A basic input/output system (BIOS) 614, containing the basic routines that help transfer information between elements within the computing system 600, such as during start-up, may be stored in the ROM 612.

Certain implementations may be configured to be connected to a global positioning system (GPS) 680, a sonar system 685, a radar system 687, and propulsion system 690. The GPS 680, the sonar system 685, the radar system 687, and/or the propulsion system 690 may be connected via the network interface 644. The computing system 600, the monitor 634, the screen 605, and buttons may be integrated into a console.

The computing system 600 may further include a hard disk drive interface 636 for reading from and writing to a hard disk 650, a memory card reader 652 for reading from and writing to a removable memory card 656, and an optical disk drive 654 for reading from and writing to a removable optical disk 658, such as a CD ROM or other optical media. The hard disk 650, the memory card reader 652, and the optical disk drive 654 may be connected to the system bus 628 by a hard disk drive interface 636, a memory card reader interface 638, and an optical drive interface 640, respectively. The drives and their associated computer-readable media may provide nonvolatile storage of computer-readable instructions, data structures, program modules and other data for the computing system 600.

Although the computing system 600 is described herein as having a hard disk, a removable memory card 656 and a removable optical disk 658, it should be appreciated by those skilled in the art that the computing system 600 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, including a Solid State Disk (SSD), CD-ROM, digital versatile disks (DVD), or other optical storage, magnetic cassettes, magnetic tape, magnetic disk storage or other magnetic storage devices, or any other medium which can be used to store the desired information and which can be accessed by the computing system 600. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 600 may also include a host adapter 633 that connects to a storage device 635 via a small computer system interface (SCSI) bus, a Fiber Channel bus, an eSATA bus, or using any other applicable computer bus interface. The computing system 600 can also be connected to a router 664 to establish a wide area network (WAN) 666 with one or more remote computers 674 (e.g., the cloud server 150). The router 664 may be connected to the system bus 628 via a network interface 644. The remote computers 674 can also include hard disks 672 that store application programs 670 (e.g., the mobile content store 190).

In another implementation, as discussed in more detail with respect to FIG. 2, the computing system 600 may also connect to one or more remote computers 674 via local area network (LAN) 676 or the WAN 666. When using a LAN networking environment, the computing system 600 may be connected to the LAN 676 through the network interface or adapter 644. The LAN 676 may be implemented via a wired connection or a wireless connection. The LAN 676 may be implemented using Wi-Fi technology, cellular technology, or any other implementation known to those skilled in the art. The network interface 644 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 664. It will be appreciated that the network connections shown are exemplary and other means of establishing a communications link between the computer systems may be used. The network interface 644 may also include digital cellular networks (e.g., GSM), Bluetooth, or any other wireless network interface.

A number of program modules may be stored on the hard disk 650, memory card 656, optical disk 658, ROM 612 or RAM 616, including an operating system 618, one or more application programs 620, and program data 624. In certain implementations, the hard disk 650 may store a database system. The database system could include, for example, recorded points. The application programs 620 may include various mobile applications (“apps”) and other applications configured to perform various methods and techniques described herein. The operating system 618 may be any suitable operating system that may control the operation of a networked personal or server computer.

A user may enter commands and information into the computing system 600 through input devices such as a keyboard 662 and pointing device. Other input devices may include a microphone, joystick, game pad, satellite dish, scanner, user input button, or the like. These and other input devices may be connected to the CPU 630 through a Universal Serial Bus (USB) interface 642 coupled to system bus 623, but may be connected by other interfaces, such as a parallel port, Bluetooth, or a game port. A monitor 605 or other type of display device may also be connected to system bus 628 via an interface, such as a video adapter 632 or a wireless interface. In addition to the monitor 634, the computing system 600 may further include other peripheral output devices such as speakers and printers.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A marine electronics device, comprising:
one or more processors; and
memory having a plurality of executable instructions which, when executed by the one or more processors, cause the one or more processors to:
determine the current software version of a software application that is configured to run on the marine electronics device or a peripheral device in communication with the marine electronics device;
receive information from a cloud server, wherein the received information describes one or more software versions released for the software application;
determine whether an update exists for the software application based on the received information and the current software version; and
download the update in response to a determination that the update exists.

2. The marine electronics device of claim 1, wherein one of the released software versions is the most recent software version offered for the software application, and wherein the executable instructions that cause the one or more processors to determine whether the update exists comprise executable instructions to determine whether the current software version is the most recent software version.

3. The marine electronics device of claim 1, wherein the executable instructions that cause the one or more processors to receive the information from the cloud server comprise executable instructions to:
determine that a network connection exists between the marine electronics device and the cloud server;
connect to the cloud server using the network connection; and
receive the information over the network connection.

4. The marine electronics device of claim 3, wherein the executable instructions that cause the one or more processors to determine that the network connection exists comprise executable instructions to determine that a wireless access point is proximate to the marine electronics device, and wherein the marine electronics device is configured to use the wireless access point to connect to the cloud server.

5. The marine electronics device of claim 3, wherein the executable instructions that cause the one or more processors to connect to the cloud server comprise executable instructions to authenticate the network connection using information stored in a user account.

6. The marine electronics device of claim 1, wherein the memory further comprises executable instructions that cause the one or more processors to control the operation of a marine vessel.

7. The marine electronics device of claim 1, wherein the received information comprises a list of released software versions for a plurality of software applications configured to run on the marine electronics device and a plurality of peripheral devices in communication with the marine electronics device.

8. The marine electronics device of claim 1, wherein the memory further comprises executable instructions that cause the one or more processors to install the update to the marine electronics device or the peripheral device.

9. The marine electronics device of claim 1, wherein the executable instructions that cause the one or more processors to download the update comprise executable instructions to:
receive, from the cloud server, a location of a site from which to download the update; and
download the update from the site.

10. The marine electronics device of claim 1, wherein the peripheral device comprises:
a radar system;
a sonar system;
a propulsion system; or
a global positioning system (GPS) device.

11. The marine electronics device of claim 1, wherein the memory further comprises executable instructions that cause the one or more processors to determine whether a user associated with the marine electronics device has granted permission to download the update, and wherein the update is downloaded in response to a determination that permission was granted.

12. A non-transitory computer-readable medium having stored thereon a plurality of computer-executable instructions which, when executed by a computer, cause the computer to:
receive information from a marine electronics device, wherein the received information describes the current software version of a software application configured to run on the marine electronics device or a peripheral device in communication with the marine electronics device;
determine whether an update exists for the software application based on the received information; and
provide a download for the update to the marine electronics device in response to a determination that the update exists.

13. The non-transitory computer-readable medium of claim 12, wherein the computer-executable instructions which, when executed by the computer, cause the computer to provide the download comprise computer-executable instructions which cause the computer to send a network address to the marine electronics device, wherein the network address corresponds to a site from which to download the update.

14. The non-transitory computer-readable medium of claim 12, wherein the computer-executable instructions which, when executed by the computer, cause the computer to provide the download comprise computer-executable instructions which cause the computer to send the update to the marine electronics device.

15. A handheld computer device, comprising:
one or more processors; and
memory having a plurality of executable instructions which, when executed by the one or more processors, cause the one or more processors to:
receive information from a marine network, wherein the received information from the marine network describes the current software version of a software application that is configured to run on a marine electronics device or a peripheral device in communication with the marine electronics device;
receive information from a cloud server, wherein the received information describes one or more software versions released for the software application;
determine whether an update exists for the software application based on the received information from the marine network and the received information from the cloud server; and
download the update in response to a determination that the update exists.

16. The handheld computer device of claim 15, wherein one of the released software versions is the most recent software version offered for the software application, and wherein the executable instructions that cause the one or more processors to determine whether the update exists comprise executable instructions to determine whether the current software version is the most recent software version.

17. The handheld computer device of claim 15, wherein the executable instructions that cause the one or more processors to receive the information from the marine network comprise executable instructions to:
detect the marine electronics device or the peripheral device on the marine network;
connect to the marine electronics device or the peripheral device over a network connection; and
receive the information from the marine network over the network connection.

18. The handheld computer device of claim 17, wherein the memory further comprises executable instructions that cause the one or more processors to send the downloaded update to the marine electronics device or the peripheral device over the network connection.

19. The handheld computer device of claim 15, wherein the executable instructions that cause the one or more processors to receive the information from the cloud server comprise executable instructions to:
determine that a network connection exists between the handheld computer device and the cloud server;
connect to the cloud server using the network connection; and
receive the information from the cloud server over the network connection.

20. The handheld computer device of claim 15, wherein the executable instructions that cause the one or more processors to download the update comprise executable instructions to:
receive, from the cloud server, a location of a site from which to download the update; and
download the update from the site.
